(19) United States
(12) Patent Application Publication
(10) Pub. No.: US 2026/0243314 A1
(43) Pub. Date: Aug. 20, 2026

(54) DETERMINING A CLUTCH TEMPERATURE OF A VEHICLE CLUTCH BY MEANS OF ON-DEMAND ACTIVATION OF A NEURAL NETWORK

(71) Applicant: ZF Friedrichshafen AG, Friedrichshafen (DE)

(72) Inventors: Markus Birk, Mittelbiberach (DE); Steffen Biel, Friedrichshafen (DE)

(73) Assignee: ZF Friedrichshafen AG, Friedrichshafen (DE)

(21) Appl. No.: 18/871,144

(22) PCT Filed: May 23, 2023
(86) PCT No.: PCT/EP2023/063762

§ 371 Date: Dec. 2, 2024

(30) Foreign Application Priority Data
Jun. 2, 2022 (DE) 10 2022 205 678.7

(51) Int. Cl. F16D 48/06; G05B 13/02; G06N 3/08; G07C 5/08

(52) U.S. Cl. CPC F16D 48/06; G05B 13/027; G06N 3/08; G07C 5/0808; F16D 2500/3024; F16D 2500/30405; F16D 2500/30412; F16D 2500/30415

(57) ABSTRACT

Determining a vehicle clutch temperature using a neural network includes detecting a shifting operation of the vehicle clutch, activating the neural network to determine the clutch temperature depending on the detection of a shifting operation, inputting at least one value of at least one operating parameter of the vehicle clutch as input data into the neural network, the neural network determining a clutch temperature using the input data and a relationship of the at least one operating parameter to the clutch temperature learned from the neural network, outputting the determined clutch temperature, and deactivating the neural network for determining the clutch temperature based on the specified clutch temperature. A method for training a neural network adapted to determine a clutch temperature of a vehicle clutch, and a control device for determining a clutch temperature of a vehicle clutch with a neural network, are also disclosed.

### RELATED APPLICATIONS

This application claims the benefit under 35 U.S.C. § 371 as a U.S. National Phase Application of application no. PCT/EP2023/063762, filed on 23 May 2023, which claims the benefit of German Patent Application no. 10 2022 205 678.7 filed on 2 Jun. 2022, the contents of which are hereby incorporated herein by reference in their entireties.

### TECHNICAL FIELD

The present invention relates to a method for determining a clutch temperature of a vehicle clutch by means of on-demand activation of a neural network. The invention also relates to a method for training a neural network adapted to determine a clutch temperature of a vehicle clutch. The invention further relates to an associated control unit for determining a clutch temperature of a vehicle clutch with on-demand activation of a neural network.

### BACKGROUND

The temperature of a vehicle clutch can be calculated using a classic rule-based mathematical model. The calculation can be carried out in a transmission control unit. Machine learning can be used for this purpose, for example a neural network. However, the embodiment of a neural network on the transmission control unit requires considerable computing power.

### SUMMARY

In a first aspect, the invention relates to a method for determining a clutch temperature of a vehicle clutch by means of a neural network.

The vehicle clutch can be installed in an engine-powered vehicle, such as a motor vehicle, a motorcycle, or an at least partially electrically powered bicycle. A drive force applied by the vehicle engine can be transferred to a drive axle of the vehicle by means of the vehicle clutch. The vehicle clutch can comprise at least two different shift states or gears, which can be defined by a predetermined ratio between the output torque of the motor and the drive torque of the drive axis.

A clutch temperature can be understood to mean the temperature of at least one clutch element, for example the temperature of a clutch disk. Alternatively, a clutch temperature can also be understood to mean a temperature of the entire vehicle clutch, which can for example be based on determining an average value of the individual temperatures of the clutch elements. The temperature of the vehicle clutch can change as a result of the operation of the vehicle. For example, the temperature of the vehicle clutch can rise during a shifting operation or a gear change. If the temperature of the vehicle clutch rises above a critical temperature value, this can lead to damage or failure of the vehicle clutch. The determination of a clutch temperature of the vehicle clutch therefore contributes to the safety of the vehicle.

A neural network can be understood to be a mathematical model that at least partially replicates the structure of the neurons in the human brain. The neural network can be created using a computer. The neural network can have input nodes, output nodes, and multiple intermediate nodes arranged between input nodes and output nodes. The input nodes can for example be data interfaces by which input data can be entered into the neural network. The output nodes can for example be data interfaces by which output data can be output from the neural network. The input nodes can be connected to the intermediate nodes and the intermediate nodes can be connected to each other. The intermediate nodes can be connected to the output nodes. The input data can be historical data collected at a specific point in time. Alternatively, or additionally, the input data can be synthetic data generated by processing recorded or measured data. Similarly, the output data can be historical data or synthetic data.

Information can be at least temporarily stored on the intermediate nodes. The invention can specify that at least one computing operation must be performed on the intermediate nodes. The intermediate nodes can transfer the input data from the input nodes to the output nodes. During this transfer, the input data can be mathematically processed, for example converted to the output data. The intermediate nodes of the neural network can be arranged in one or more layers or levels. The intermediate nodes can be connected to one another within a layer. The intermediate nodes of one layer can be additionally connected to the intermediate nodes of other layers. The individual connections of the input nodes, the intermediate nodes, and the output nodes can have mathematical weightings. The individual weightings of the connections can vary depending on the purpose of the neural network. The weightings can be changed while training the neural network. By adjusting the mathematical weightings of the connections of the individual nodes during training, the neural network can learn a relationship between the input data and the output data. During the use of the neural network for the intended purpose, the neural network can apply the learned relationship to entered input data in order to generate output data according to the predetermined intended use of the neural network.

For example, a multi-layer perceptron, MLP, can be used as a neural network to determine a clutch temperature. This neural network has at least one layer of intermediate nodes and uses at least one non-linear mathematical function to calculate the output data. Another exemplary neural network for determining a clutch temperature can be a Fully Connected Layer, FCL, network. All input nodes, intermediate nodes, and output nodes on this neural network are connected to one another. Furthermore, for example a convolutional neural network can be used to determine a clutch temperature, wherein the intermediate nodes of different layers are at least partially connected to one another in the form of a mathematical convolution function.

The method comprises the step of detecting a shifting operation of the vehicle clutch. A shifting operation can be carried out manually, for example by actuating a pedal by the driver of the motor vehicle, or automatically by a shifting program of the motor vehicle. A shifting operation of the vehicle clutch can be detected by changing at least one operating parameter of the vehicle clutch. For example, the speed of a clutch element of the vehicle clutch can change when the shifting operation is carried out. Alternatively, or additionally, the load on a clutch element of the vehicle clutch can change during the shifting operation. Alternatively, or additionally, during the shifting operation, the current of an electrical current flowing through a clutch element of the vehicle clutch can change. Alternatively, or additionally, a shifting operation can be detected by changing a target gear of the vehicle clutch.

The method further comprises the step of activating the neural network to determine the clutch temperature. The neural network is activated based on the detection of the shifting operation. By detecting the shifting operation, an activation signal can be generated, for example by a control unit of the vehicle. This control signal can be used to activate the neural network. For example, this control signal can be transmitted to an activation unit, which can be adapted to activate the neural network depending on the reception of the control signal. Activation of the neural network can be understood to mean the beginning of a calculation performed by the neural network. Alternatively or additionally, an activation of the neural network can be understood to mean data access of the neural network to data necessary for the calculation.

The method further comprises the step of inputting at least one value of at least one operating parameter of the vehicle clutch as input data into the neural network. The at least one value of the at least one operating parameter of the vehicle clutch can be representative of a power supplied to the vehicle clutch. Alternatively, or additionally, the at least one value of the at least one operating parameter of the vehicle clutch can be representative of a clutch temperature of the vehicle clutch. The at least one value of the at least one operating parameter can, for example, be transmitted to at least one of the input nodes of the neural network by means of an input device. Alternatively, the at least one value of the at least one operating parameter can be transmitted from a control device of the vehicle over a data interface to at least one of the input nodes of the neural network. The at least one value of the at least one operating parameter can be used as input data for using the neural network to determine the clutch temperature. Alternatively, or additionally, the at least one value of the at least one operating parameter can be used as input data for training the neural network.

The method further comprises the step of determining a clutch temperature by the neural network. The neural network determines the clutch temperature based on the input data and based on a relationship of the at least one operating parameter to the clutch temperature learned from the neural network. The input data can be processed by the neural network according to the learned relationship, for example on the intermediate node, in order to determine the clutch temperature. While learning the relationship, the neural network can change the mathematical weighting of the connections of the individual nodes to determine the clutch temperature.

The method further comprises the step of outputting the determined clutch temperature by the neural network. The determined clutch temperature can be output by the neural network to a device adapted for electrical signal processing. The clutch temperature determined and output by the neural network can be used by other vehicle control components. For example, a control value for a control unit of the vehicle, for example a transmission control for an automatic transmission, can be generated using the determined clutch temperature. The control value can also be displayed on a display unit of the vehicle. Alternatively, or additionally, the control value that is based on the clutch temperature can be processed by an evaluation unit, which, for example, is adapted to monitor the driving safety of the vehicle.

The method further comprises the step of deactivating the neural network to determine the clutch temperature. The neural network is deactivated depending on the specific clutch temperature. Deactivating the neural network can be understood to mean ending or aborting the calculation of the clutch temperature by the neural network. Alternatively, or additionally, deactivating the neural network can be understood to mean ending or terminating data access of the neural network to input data. The neural network can be deactivated by a control unit of the vehicle adapted for this purpose. Alternatively, the neural network can be deactivated by the neural network itself. For this purpose, the invention can specify that the neural network is trained to detect a deactivation condition based on which the neural network is deactivated. To deactivate the neural network, the specific clutch temperature can be processed to determine a deactivation condition dependent on the clutch temperature. Alternatively, the specific clutch temperature can be used directly, i.e. unprocessed, to deactivate the neural network.

The proposed method enables determining a clutch temperature by means of a neural network. As a result, the use of classic mathematical models, which are generally very complex and therefore time-consuming to calculate, can be omitted. By using a neural network, the computing time required to determine the clutch temperature can thus firstly be reduced. Secondly, the proposed method enables the on-demand activation of the neural network to determine the clutch temperature. The neural network is only activated when a shifting operation of the vehicle clutch is detected. During a shifting operation, the vehicle clutch is generally subjected to higher loads than in a driving mode during which no shift occurs. Due to this higher load on the vehicle clutch, a particular fluctuation in the clutch temperature is to be expected during the shifting operation. This fluctuation of the clutch temperature must therefore be monitored particularly. However, when no shifting operation occurs, lower fluctuations of the clutch temperature generally occur. Therefore, it is not mandatory to determine or monitor the clutch temperature during this period. The neural network can therefore be deactivated during this period. The proposed method can for example be carried out on a transmission control unit. In this case, the on-demand activation of the neural network enables the on-demand distribution of the computing capacity available on the transmission control unit, such as memory available for computing and/or a computing time available for computing. The neural network accesses this computing capacity only when a shifting operation is detected. If no shifting operation is detected, the computing capacity of the transmission control unit can be used elsewhere, for example to ensure the functionality of the transmission.

According to one embodiment, the neural network is deactivated when the determined clutch temperature is below a defined threshold value. The defined threshold value can be defined by a user, for example a driver of the vehicle. Alternatively, the threshold value can be defined by a manufacturer of the vehicle. The defined threshold value of the clutch temperature can be representative of a clutch temperature below which the probability of damage to the vehicle clutch due to a temperature rise is sufficiently low. The defined threshold can be based on empirical values. Alternatively, or additionally, the defined threshold value can be based on mathematical calculations or experimental testing. The defined threshold value can be selected differently for different vehicle clutches. The invention can specify that a determination or monitoring of the clutch temperature is no longer necessary below the defined threshold value. For example, below the defined threshold value, damage to the clutch due to a temperature increase can be ruled out with sufficient probability. If the clutch temperature falls below the defined threshold value, it is no longer mandatory for the neural network to determine the clutch temperature. The neural network can therefore be deactivated. The determination of a defined threshold value for the clutch temperature below which the neural network is deactivated thus improves the driving safety of the vehicle.

According to a further embodiment, the clutch temperature is determined by the neural network within a predetermined time interval. The predetermined time interval can be specified by a user, for example a driver of the vehicle. Alternatively, the time interval can be specified by a manufacturer of the vehicle. If the clutch temperature is determined by the neural network on a transmission control unit, the time interval can be specified depending on the computing capacity available on the transmission control unit. For example, the invention can specify that the neural network can use a maximum of 20% or a maximum of 10% or a maximum of 5% or a maximum of 1% of the total computing time available on the transmission control unit to determine the clutch temperature. The determination of the clutch temperature by the neural network within the specified time interval can be repeated at regular intervals as long as the neural network is activated. Alternatively, the neural network can determine the clutch temperature within the specified time interval based on a predetermined maximum number, for example once or twice or three times. If the maximum number of specified calculation runs has been reached, the invention can specify that no further determination of the clutch temperature is carried out by the neural network. By specifying the time interval within which the neural network determines the clutch temperature, the determination method can be adapted to different types of vehicle clutches or different types of control units on which the determination is carried out. Furthermore, the computing capacity available for determining the clutch temperature by the neural network can be adjusted by specifying the time interval to specific requirements, for example of the user or the manufacturer.

According to a further embodiment, the predetermined time interval is predetermined depending on the determined clutch temperature. For example, the invention can specify that the selected time interval is the shorter the higher the specific clutch temperature. In this case, the clutch temperature can be determined more frequently at comparatively high clutch temperatures than at comparatively low clutch temperatures. The present invention does not restrict other forms of temperature-dependent determination of the time interval. The temperature-dependent determination of the time interval allows an adjustment of the determination method to various operating states of the vehicle clutch.

According to one embodiment, the method further comprises a step of determining at least one input value representative of a power supplied to the vehicle clutch. The at least one input value is determined based on processing chronologically consecutive values for the power supplied to the vehicle clutch. The power supplied to the vehicle clutch can be understood to be a physical power, i.e. an amount of energy supplied to the vehicle clutch during a predetermined period of time. For example, the power supplied to the vehicle clutch can be a shift power supplied to the vehicle clutch during a shifting operation or a gear change of the latter. The power supplied to the vehicle clutch can be representative of a change in the clutch temperature of the vehicle clutch.

The power supplied to the vehicle clutch can be recorded at certain intervals. The individual values for the power supplied to the vehicle clutch can be arranged in ascending order, for example according to their detection time. These chronologically consecutive values for the power supplied to the vehicle clutch can be mathematically processed, for example by means of a predetermined computing operation such as the formation of an average value.

In this embodiment, the method further comprises the step of inputting the at least one input value as input data into the neural network. The at least one input value can, for example, be transmitted to at least one of the input nodes of the neural network by means of an input device. Alternatively, the at least one input value can be transmitted from a control device of the vehicle via a data interface to at least one of the input nodes of the neural network. The at least one input value can be used as input data for using the neural network to determine the clutch temperature. Alternatively, or additionally, the at least one input value can be used as input data for training the neural network.

In this embodiment, determining the clutch temperature is further based on a change of the input data over time. The neural network can thus also take into account a change of the input data over time. For example, a cooling or heating-up phase of the vehicle clutch can be detected and taken into account when determining the clutch temperature. Furthermore, for example the exceeding of a limit value for the clutch temperature or a deviation from a standard behavior of the clutch temperature during the heating-up or cooling phase can be taken into account. The clutch temperature can therefore also be determined more precisely by the neural network. Furthermore, the change of the input data over time is not determined by the neural network itself, but is instead only transmitted to the latter in the form of the processed input value. This reduces the computing effort required to determine the clutch temperature. The structure of the neural network can thus be adapted to be less complex. Therefore, the storage space required for the neural network can also be reduced.

According to one embodiment, the at least one input value is determined at predetermined time intervals. For example, the at least one input value can be determined in time intervals of 1 second, 100 ms or 10 ms. The determination of the input value can thus be adapted to the time intervals within which the neural network determines the clutch temperature, Thus, the neural network has a current input value, i.e. within the same time interval of certain input values, within which the clutch temperature is determined by the neural network. The clutch temperature can thus be determined even more precisely by the neural network. Since the determination of the input value generates a low computing load, an efficient calculation with simultaneous high performance can be carried out by executing the determination of the input value decoupled from the execution of the neural network.

In a second aspect, the invention relates to a method for training a neural network adapted to determine a clutch temperature of a vehicle clutch. The method has the following steps: Provide at least one value of an operating parameter of the vehicle clutch as input data; provide values for the clutch temperature as output data; and train the neural network with the input data and the output data in order to learn a connection between the input data and the clutch temperature.

The values for the at least one operating parameter of the vehicle clutch and the values for a clutch temperature can be acquired by means of devices adapted for electrical signal processing. The acquired values can be provided to an input device for inputting input data into the neural network. Alternatively, the acquired values can be transmitted to the input nodes of the neural network by the devices adapted for this purpose over a data interface. Alternatively, or additionally, the input data or the output data can be available as synthetic data, which can be generated by converting acquired or specified data.

According to one embodiment, the neural network is further trained by means of at least one specific input value representative for a power supplied to the vehicle clutch. The at least one input value is determined based on processing chronologically consecutive values for the power supplied to the vehicle clutch.

According to one embodiment, the neural network is trained according to the method of the first aspect according to the method of the second aspect. This allows the technical effects and advantages of the two aspects to be combined.

According to one embodiment, the at least one operating parameter of the vehicle clutch is selected from at least one of the following: a torque of a drive axis of a vehicle engine that has an operational mechanical connection to the vehicle clutch; a speed difference between two rotating clutch elements of the vehicle clutch; a rotational speed of a rotating clutch element of the vehicle clutch; a mechanical pressure acting on a clutch element of the vehicle clutch; an electrical current flowing through a clutch element of the vehicle clutch; and a sump temperature of a vehicle transmission at the start of a shifting operation of the vehicle clutch. Clutch elements can for example be the clutch disks of a vehicle clutch, which can be connected to the drive axis for the purpose of transmitting torque from the engine. The above parameters can be representative of a power supplied to the vehicle clutch. Alternatively, or additionally, the above parameters can be representative for a clutch temperature of the vehicle clutch. By using at least one of these parameters, the determination of the clutch temperature can thus be simplified.

In a third aspect, the invention relates to a control device for determining a clutch temperature of a vehicle clutch. The control device comprises a computer-readable storage medium on which a neural network for determining the clutch temperature is stored. The control device further comprises a detection device for detecting a shifting operation of the vehicle clutch and an activation device for activating the neural network depending on the detection of a shifting operation. The control device further comprises an input device for inputting input data into the neural network, wherein the input data comprises at least one value of at least one operating parameter of the vehicle clutch. The control device further comprises an output device for outputting the determined clutch temperature by the neural network and a deactivation device for deactivating the neural network depending on the determined clutch temperature.

According to one embodiment, the clutch temperature is determined by the neural network according to the method according to the first aspect. Furthermore, the neural network was trained according to the method according to the second aspect.

The aforementioned devices of the control device according to the third aspect can be adapted to receive, process and transmit electrical signals. The aforementioned devices of the control device according to the third aspect can be adapted to carry out the method according to the first aspect and/or the second aspect. Similarly, the method according to the first aspect or the second aspect can be carried out by the control device according to the third aspect. The embodiments, technical effects and advantages explained regarding the first or second aspect thus apply analogously to the control device according to the third aspect.

### BRIEF DESCRIPTION OF THE DRAWINGS

FIG. 1 shows a flow diagram with steps of a method for determining a clutch temperature of a vehicle clutch by means of a neural network, according to one embodiment of the invention.

FIG. 2 shows a flow diagram with steps of a method for training a neural network adapted to determine a clutch temperature of a vehicle clutch, according to a further embodiment of the invention.

FIG. 3 schematically shows a control unit for determining a clutch temperature of a vehicle clutch with a neural network according to a further embodiment of the invention.

### DETAILED DESCRIPTION OF EMBODIMENTS

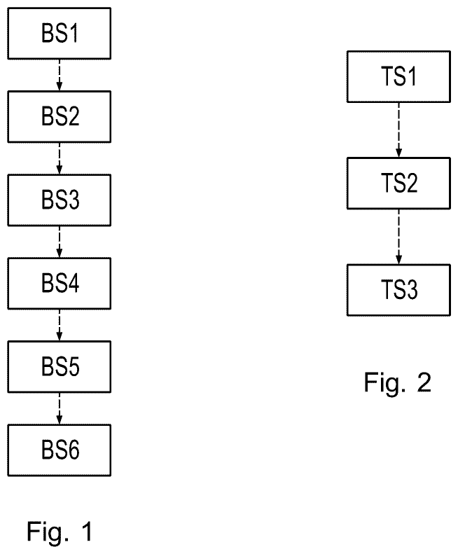

FIG. 1 shows a flow diagram with steps of a method for determining a clutch temperature of a vehicle clutch by means of a neural network according to one embodiment of the invention.

In a first determination step BS1, a shifting operation of the vehicle clutch is detected. In the exemplary embodiment of FIG. 1, the shifting operation is detected by means of a change of the target gear of the vehicle clutch.

In a second determination step BS2, the neural network is activated to determine the clutch temperature. Activation takes place depending on the detection of the shifting operation. The activation takes place in the exemplary embodiment of FIG. 1 using an activation signal generated by an activation device when a shifting operation is detected.

In a third determination step BS3, at least one value of at least one operating parameter of the vehicle clutch is entered into the neural network as input data. The at least one value of the at least one operating parameter is in this case transmitted to at least one input node of the neural network.

In a fourth determination step BS4, a clutch temperature is determined by the neural network. The clutch temperature is determined based on the input data and based on a relationship learned from the neural network between the input data and the clutch temperature.

To determine the clutch temperature, the input data transmitted to the input nodes of the neural network is transmitted to intermediate nodes of the neural network based on connections mathematically weighted by the neural network. The intermediate node processes the transmitted input data and transmits connections mathematically weighted by the neural network to the output nodes of the neural network. The mathematical weighting of the respective connections was adjusted by the neural network during a training process of the neural network preceding the determination procedure based on a training data set. At the end of the procedure execution, at least one output node of the neural network has a value for a clutch temperature.

In a fifth determination step BS5, the determined clutch temperature is output by the neural network. In the exemplary embodiment of FIG. 1, the clutch temperature is output to an output device.

In a sixth determination step BS6, the neural network is deactivated for determining the clutch temperature. Deactivation is carried out depending on the specified clutch temperature. In the exemplary embodiment of FIG. 1, the deactivation of the neural network occurs when the determined clutch temperature is below a defined threshold value.

Depending on the detection of a shifting operation, the neural network can be activated as needed. Furthermore, the neural network can be deactivated on-demand depending on the specified clutch temperature. The determination of the clutch temperature by the neural network can thus be adapted to the predetermined computing capacity of a control device, on which the determination by the neural network takes place.

FIG. 2 shows a flow diagram with steps of a method for training a neural network adapted to determine a clutch temperature of a vehicle clutch, according to a further embodiment of the invention.

In a first training step TS1, at least one value of at least one operating parameter of the vehicle clutch is provided as input data. This value is representative for a clutch temperature of the vehicle clutch and is transmitted to at least one input node of the neural network.

In a second training step TS2, values for a clutch temperature are provided as output data. These values are measurands for the clutch temperature. In a not shown exemplary embodiment, the values for the clutch temperature are generated synthetically. These values are transmitted to at least one output node of the neural network.

In a third training step TS3, the neural network is trained with the input data and the output data in order to learn a relationship between the input data and the clutch temperature.

The neural network used to determine the clutch temperature according to the embodiment of FIG. 1 can be trained according to the method of the embodiment of FIG. 2.

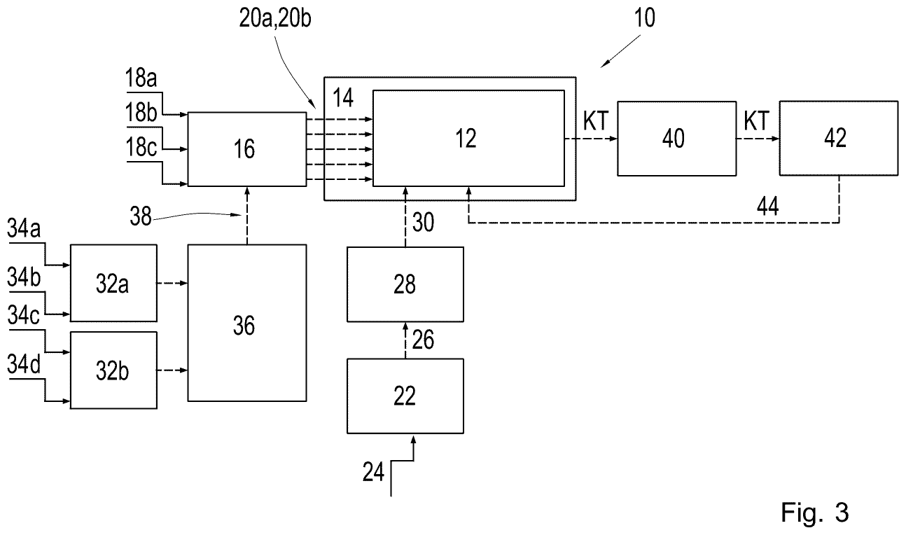

FIG. 3 schematically shows a control unit 10 for determining a clutch temperature of a not shown vehicle clutch with a neural network 12 according to a further embodiment of the invention.

The control device 10 comprises a computer-readable storage medium 14 on which the neural network 12 is stored. The control device 10 further comprises an input device 16 adapted to receive values 18a, 18b, 18c of operating parameters of the vehicle clutch. The input device 16 transmits the values 18a, 18b, 18c of the operating parameters of the vehicle clutch as input data 20a to the neural network 12.

The control device 10 comprises a detection device 22 that detects a shifting operation of the vehicle clutch on the basis of a shifting signal 24. Depending on the detected shifting operation, the detection device 22 generates a detection signal 26 and transmits the latter to an activation device 28. The activation device 28 generates an activation signal 30 depending on the reception of the detection signal 26 and transmits the latter to the neural network 12. Depending on the reception of the activation signal 30, the neural network 12 is activated.

The control device 10 further comprises detection devices 32a, 32b that record chronologically consecutive values 34a, 34b or 34c, 34d for a power supplied to the vehicle clutch. The detection devices 32a, 32b are low-pass filters and the values 34a, 34b, 34c, 34d for a power supplied to the vehicle clutch are a shift power supplied to the vehicle clutch during a shifting operation or gear change. The detected values 34a, 34b, 34c, and 34d for the shifting power are transmitted from the detection devices 32a, 32b to a determination device 36. The determination device 36 determines at least one average for the shifting power by processing the chronologically consecutive values 34a, 34b, 34c, 34d. The at least one average value for the shifting power is transmitted from the determination device 36 as an input value 38 to the input device 16. The input device 16 transmits the input value 38 as input data 20 b to the neural network 12.

From the input data 20a, 20b, a clutch temperature KT of the vehicle clutch is determined by the neural network 12. The determined clutch temperature KT is transmitted by the neural network 12 to an output device 40. The output device 40 transfers the determined clutch temperature KT to a deactivation device 42. Depending on the determined clutch temperature KT, the deactivation device 42 generates a deactivation signal 44, by means of which the neural network 12 can be deactivated. In the exemplary embodiment of FIG. 3, the deactivation signal 44 for the neural network 12 is generated when the determined clutch temperature CT is below a defined threshold value.

### LIST OF REFERENCE NUMERALS

10 Control unit
12 Neural network
14 Storage medium
16 Input device
18a, 18b, 18c Values of operating parameters
20a, 20b Input data
22 Detection device
24 Shifting signal
26 Detection signal
28 Activation device
30 Activation signal
32a, 32b Detection devices
34a, 34b, Chronologically consecutive values for a power supplied to the vehicle clutch 34c, 34d
36 Determination device
38 Input value
40 Output device
42 Deactivation device
44 Deactivation signal
KT Clutch temperature
BS1 First determination step
BS2 Second determination step
BS3 Third determination step
BS4 Fourth determination step
BS5 Fifth determination step
BS6 Sixth determination step
TS1 First training step
TS2 Second training step
TS3 Third training step

1. A method for determining a clutch temperature of a vehicle clutch by means of a neural network (12), the method comprising:
detecting (BS1) a shifting operation (24) of the vehicle clutch;
activating (BS2) the neural network (12) to determine the clutch temperature, depending on the detection of a shifting operation (24);
inputting (BS3) at least one value (18a, 18b, 18c) of at least one operating parameter of the vehicle clutch as input data (20a) into the neural network (12);
determining (BS4) a clutch temperature (KT) by the neural network (12), based on the input data (20a) and a relationship of the at least one operating parameter to the clutch temperature (KT) learned from the neural network (12);
outputting (BS5) the determined clutch temperature (KT) by the neural network (12); and
deactivating (BS6) the neural network (12) to determine the clutch temperature, depending on the determined clutch temperature (KT).

2. The method according to claim 1, wherein deactivating the neural network (12) is performed when the determined clutch temperature (KT) is determined to be below a defined threshold value.

3. The method according to CLAIM 1, wherein determining the clutch temperature is performed by the neural network (12) within a predetermined time interval.

4. The method according to claim 3, comprising specifying the time interval based on the determined clutch temperature.

5. The method according to claim 1, wherein the method further comprises the following steps:
determining at least one input value (38) representative of a power supplied to the vehicle clutch, wherein determining the at least one input value (38) is based on a processing of chronologically consecutive values (32a, 32b, 32c, 32d) for the power supplied to the vehicle clutch; and
inputting the at least one input value (38) as input data (20b) into the neural network (12).

6. The method according to claim 5, wherein the at least one input value (38) is determined at predetermined time intervals.

7. A method for training a neural network (12) adapted to determine a clutch temperature (KT) of a vehicle clutch, wherein the method comprises the following steps:
providing (TS1) at least one value (18a, 18b, 18c) of an operating parameter of the vehicle clutch as input data (20a);
providing (TS2) values for the clutch temperature as output data; and
training (TS3) the neural network (12) with the input data (20a) and the output data in order to learn a relationship between the input data and the clutch temperature.

8. The method according to claim 7, wherein training the neural network (12) further uses at least one specific input value (38) representative for a power supplied to the vehicle clutch, and wherein determining the at least one input value (38) includes processing chronologically consecutive values (32a, 32b, 32c, 32d) for the power supplied to the vehicle clutch.

9. The method according to claim , wherein training the neural network (12) comprises:
providing (TS1) at least one value (18a, 18b, 18c) of an operating parameter of the vehicle clutch as input data (20a):
providing (TS2) values for the clutch temperature as output data; and
training (TS3) the neural network (12) with the input data (20a) and the output data in order to learn a relationship between the input data and the clutch temperature.

10. The method according to claim 1, comprising:
selecting the at least one operating parameter of the vehicle clutch from at least one of (i) a torque of a drive axis of a vehicle engine, which is in mechanical operative connection with the vehicle clutch, (ii) a speed difference between two rotating clutch elements of the vehicle clutch, (iii) a rotational speed of a rotating clutch element of the vehicle clutch, (iv) a mechanical pressure acting on a clutch element of the vehicle clutch, (v) a current intensity of an electrical current flowing through a clutch element of the vehicle clutch, and (vi) a sump temperature of a vehicle transmission at the start of a shifting operation of the vehicle clutch.

11. A control device (10) for determining a clutch temperature of a vehicle clutch, the control device comprising:
a computer-readable storage medium (14), on which a neural network (12) for determining the clutch temperature is stored;
a detection device (22) for detecting a shifting operation (24) of the vehicle clutch;
an activation device (28) for activating (30) the neural network (12), depending on the detection (24) of a shifting operation;
an input device (16) for inputting input data (20a, 20b) into the neural network (12), wherein the input data (20a, 20b) comprises at least one value (18a, 18b, 18c) of at least one operating parameter of the vehicle clutch;
an output device (40) for outputting the determined clutch temperature (KT) by the neural network (12); and
a deactivation device for deactivating the neural network (12), depending on the determined clutch temperature (KT).

12. The control device (10) according to claim 11, wherein:
the clutch temperature (KT) is determined by a neural network (12) configured to perform the following steps:
detecting (BS1) a shifting operation (24) of the vehicle clutch;
activating (BS2) the neural network (12) to determine the clutch temperature. depending on the detection of a shifting operation (24);
inputting (BS3) at least one value (18a, 18b, 18c) of at least one operating parameter of the vehicle clutch as input data (20a) into the neural network (12);
determining (BS4) a clutch temperature (KT) by the neural network (12), based on the input data (20a) and a relationship of the at least one operating parameter to the clutch temperature (KT) learned from the neural network (12);
outputting (BS5) the determined clutch temperature (KT) by the neural network (12); and
deactivating (BS6) the neural network (12) to determine the clutch temperature. depending on the determined clutch temperature (KT); and
the neural network (12) was trained according to the the following steps.
providing (TS1) at least one value (18a, 18b, 18c) of an operating parameter of the vehicle clutch as input data (20a);
providing (TS2) values for the clutch temperature as output data; and
training (TS3) the neural network (12) with the input data (20a) and the output data in order to learn a relationship between the input data and the clutch temperature.

13. The method according to claim 9, wherein:
training the neural network (12) uses at least one specific input value (38) representative for a power supplied to the vehicle clutch, and
determining the at least one input value (38) includes processing chronologically consecutive values (32a, 32b, 32c, 32d) for the power supplied to the vehicle clutch.
